(19) United States
(12) Patent Application Publication
(10) Pub. No.: US 2010/0118316 A1
(43) Pub. Date: May 13, 2010

(54) AUTO FOCUS ARRAY DETECTOR OPTIMIZED FOR OPERATING OBJECTIVES

(75) Inventors: MIHAIL MIHAYLOV, SAN JOSE, CA (US); MANUEL MADRIAGA, SAN JOSE, CA (US)

Correspondence Address: Tokyo Electron U.S. Holdings, Inc., 4350 West Chandler Blvd., Suite 10/11, Chandler, AZ, 85226, US

(73) Assignee: TOKYO ELECTRON LIMITED, TOKYO (JP)

(21) Appl. No.: 12/270,799

(22) Filed: Nov. 13, 2008

(51) Int. Cl. G02B 5/18

(52) U.S. Cl. 356/625; 702/155

(57) ABSTRACT

Provided are an apparatus and a method of measuring structures on a workpiece using an optical metrology system, the optical metrology system comprising an auto focus subsystem which includes a motion control system and a focus detector. The focus detector includes an array of sensors where each sensor has identification (ID). The focus detector measures the focus beam and converts the measurements into a focus signal for each sensor. The focus signal and associated ID of each sensor are transmitted to a processor that generates a best focus instruction. A motion control system utilizes the best focus instruction to move the workpiece to the best focus location. The auto focusing of the workpiece is performed to meet set operating objectives of the auto focus subsystem.

### BACKGROUND

1. Field

The present application generally relates to the design of an optical metrology system to measure a structure formed on a workpiece, and, more particularly, to a method and an apparatus for optimizing the operating objectives of a focus detector using an array of sensors to perform auto focusing on the workpiece.

2. Related Art

Optical metrology involves directing an incident beam at a structure on a workpiece, measuring the resulting diffraction signal, and analyzing the measured diffraction signal to determine various characteristics of the structure. The workpiece can be a wafer, a substrate, a photomask or a magnetic medium. In manufacturing of the workpieces, periodic gratings are typically used for quality assurance. For example, one typical use of periodic gratings includes fabricating a periodic grating in proximity to the operating structure of a semiconductor chip. The periodic grating is then illuminated with an electromagnetic radiation. The electromagnetic radiation scattered by the periodic grating is collected as a diffraction signal. The diffraction signal is then analyzed to determine whether the periodic grating and, by extension, whether the operating structure of the semiconductor chip has been fabricated according to specifications.

In one conventional system, the diffraction signal collected from illuminating the periodic grating (the measured diffraction signal) is compared to a library of simulated diffraction signals. Each simulated diffraction signal in the library is associated with a hypothetical profile. When a match is made between the measured diffraction signal and one of the simulated diffraction signals in the library, the hypothetical profile associated with the simulated diffraction signal is presumed to represent the actual profile of the periodic grating. The hypothetical profiles, which are used to generate the simulated diffraction signals, are generated based on a profile model that characterizes the structure to be examined. Thus, in order to accurately determine the profile of the structure using optical metrology, a profile model that accurately characterizes the structure should be used.

With increased requirement for throughput, decreasing size of the test structures, smaller spot sizes, and lower cost of ownership, there is greater need to optimize the design of optical metrology systems to meet several design goals. Characteristics of the optical metrology system including throughput, range of measurement capabilities, accuracy and repeatability of diffraction signal measurements are essential to meeting the increased requirement for smaller spot size and lower cost of ownership of the optical metrology system. Accurate and rapid auto focusing of the workpiece contributes to meeting the above objectives of the optical metrology system.

### SUMMARY

Provided is a method of measuring structures on a workpiece using an optical metrology system, the optical metrology system comprising an auto focus subsystem which includes a motion control system and a focus detector. The focus detector includes an array of sensors where each sensor has identification (ID). The focus detector measures the focus beam and converts the measurements into a focus signal for each sensor. The focus signal and associated ID of each sensor are transmitted to a processor that generates a best focus instruction. A motion control system utilizes the best focus instruction to move the workpiece to the best focus location. The auto focusing of the workpiece is performed to meet set operating objectives of the auto focus subsystem.

### BRIEF DESCRIPTION OF DRAWINGS

FIG. 1 is an architectural diagram illustrating an exemplary embodiment where an optical metrology system can be utilized to determine the profiles of structures formed on a semiconductor wafer.

FIG. 2 depicts an exemplary optical metrology system in accordance with embodiments of the invention.

FIG. 3A depicts an exemplary focus detection sensor array where the sensors include a pitch and identification.

FIG. 3B depicts an exemplary graph of the detector signal measured for the sensors identified and the incremental error between the calibrated best focus signal for the workpiece and highest detector signal of the current Z-axis position of the workpiece.

FIG. 4A depicts an architectural diagram illustrating an auto focusing subsystem of an optical metrology tool whereas FIG. 4B depicts an architectural diagram illustrating focus illumination beams and focus detection beams with the workpiece at different positions on the Z-axis.

FIG. 5 depicts an exemplary flowchart for auto focusing the workpiece in the Z-axis using an auto focus detector with an array of sensors.

FIG. 6 depicts an exemplary flowchart for designing an auto focus subsystem of an optical metrology system to meet a time objective, and for using the optical metrology system to extract structure profile parameters of a workpiece and control a fabrication process.

FIG. 7 is an exemplary block diagram of a system for determining and utilizing profile parameters for automated process control and equipment control.

FIG. 8A depicts an exemplary graph of the focus signal measured for the sensors identified and data point characteristics of the best fitting curve.

FIG. 8B depicts an exemplary graph of the focus signal measured for the sensors identified including noise in the signal indicating a non-uniform focus detection beam.

FIG. 9 depicts an exemplary flowchart for generating the best focus instruction for an auto focus detector with an array of sensors.

FIG. 10 depicts an architectural diagram illustrating an auto focusing subsystem of an optical metrology tool where the focusing subsystem includes an analog-to-digital converter.

FIG. 11 depicts an exemplary flowchart for auto focusing the workpiece in the Z-axis using an auto focus detector with an array of sensors where the operating parameters are optimized to meet operating objectives.

### DETAILED DESCRIPTION

In order to facilitate the description of the present invention, a semiconductor wafer may be utilized to illustrate an application of the concept. The systems and processes equally apply to other workpieces that have repeating structures. The workpiece may be a wafer, a substrate, disk, or the like. Furthermore, in this application, the term structure when it is not qualified refers to a patterned structure.

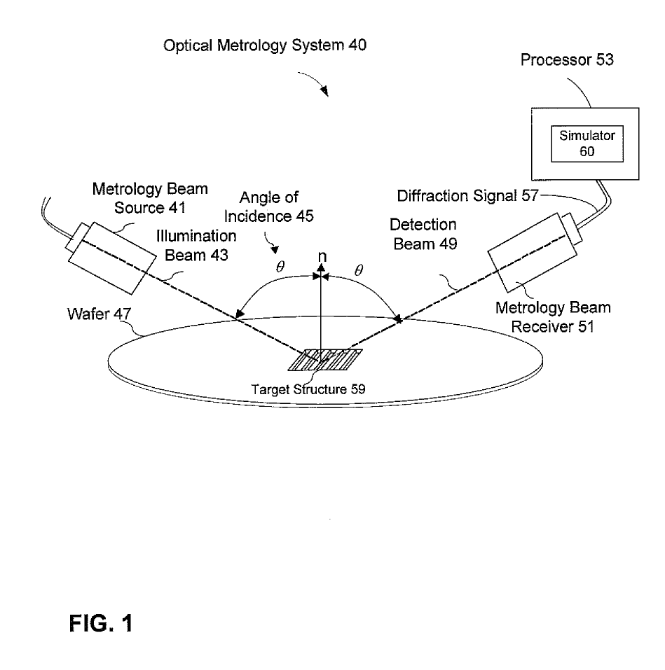

FIG. 1 is an architectural diagram illustrating an exemplary embodiment where optical metrology can be utilized to determine the profiles or shapes of structures fabricated on a semiconductor wafer. The optical metrology system 40 includes a metrology beam source 41 projecting a metrology illumination beam 43 at the target structure 59 on a wafer 47. The metrology beam 43 is projected at an incidence angle θ (label 45 in FIG. 1) towards the target structure 59. The diffracted detection beam 49 is measured by a metrology beam receiver 51. A measured diffraction signal 57 is transmitted to a processor 53. The processor 53 compares the measured diffraction signal 57 against a simulator 60 of simulated diffraction signals and associated hypothetical profiles representing varying combinations of critical dimensions of the target structure and resolution. The simulator can be either a library that consists of a machine learning system, pre-generated data base and the like (e.g., this is a library system), or on demand diffraction signal generator that solves the Maxwell equation for a giving profile (e.g., this is a regression system). In one exemplary embodiment, the diffraction signal generated by the simulator 60 instance best matching the measured diffraction signal 57 is selected. The hypothetical profile and associated critical dimensions of the selected simulator 60 instance are assumed to correspond to the actual cross-sectional shape and critical dimensions of the features of the target structure 59. The optical metrology system 40 may utilize a reflectometer, an ellipsometer, or other optical metrology device to measure the diffraction beam or signal. An optical metrology system is described in U.S. Pat. No. 6,943,900, entitled “GENERATION OF A LIBRARY OF PERIODIC GRATING DIFFRACTION SIGNAL”, issued on Sep. 13, 2005, which is incorporated herein by reference in its entirety.

Simulated diffraction signals can be generated by applying Maxwell's equations and using a numerical analysis technique to solve Maxwell's equations. It should be noted that various numerical analysis techniques, including variations of rigorous coupled-wave analyses (RCWA), can be used. For a more detail description of RCWA, see U.S. Pat. No. 6,891,626, titled CACHING OF INTRA-LAYER CALCULATIONS FOR RAPID RIGOROUS COUPLED-WAVE ANALYSES, filed on Jan. 25, 2001, issued May 10, 2005, which is incorporated herein by reference in its entirety.

Simulated diffraction signals can also be generated using a machine learning system (MLS). Prior to generating the simulated diffraction signals, the MLS is trained using known input and output data. In one exemplary embodiment, simulated diffraction signals can be generated using an MLS employing a machine learning algorithm, such as back-propagation, radial basis function, support vector, kernel regression, and the like. For a more detailed description of machine earning systems and algorithms, see U.S. patent application Ser. No. 10/608,300, entitled “OPTICAL METROLOGY OF STRUCTURES FORMED ON SEMICONDUCTOR WAFERS USING MACHINE LEARNING SYSTEMS”, filed on Jun. 27, 2003, which is incorporated herein by reference in its entirety.

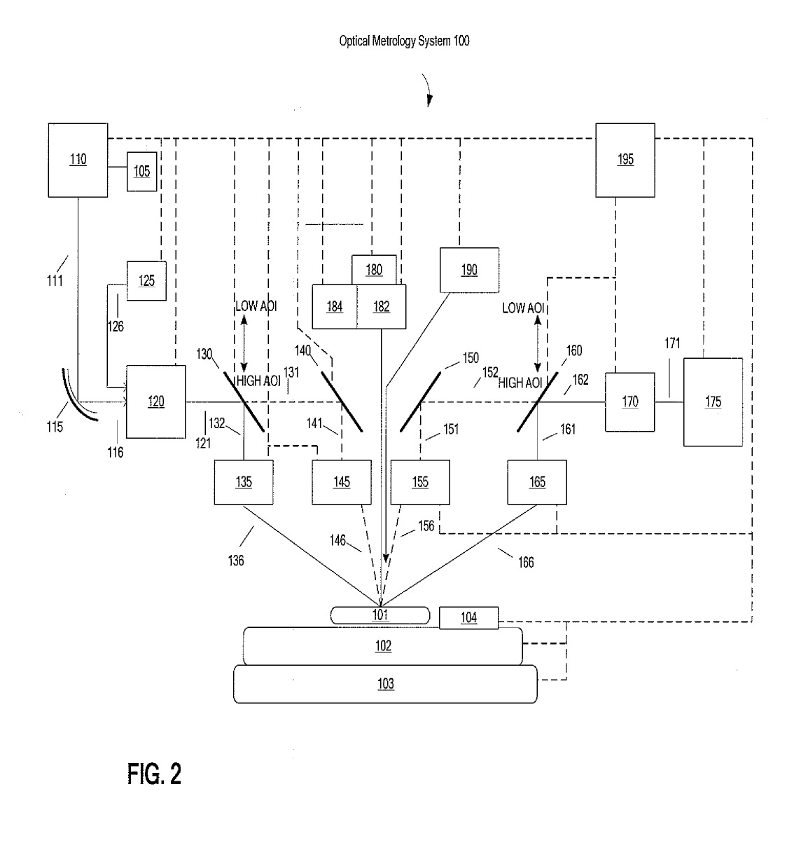

FIG. 2 shows an exemplary block diagram of an optical metrology system in accordance with embodiments of the invention. In the illustrated embodiment, an optical metrology system 100 can comprise a lamp subsystem 105, and at least two optical outputs 106 from the lamp subsystem can be transmitted to an illuminator subsystem 110. At least two optical outputs 111 from the illuminator subsystem 110 can be transmitted to a selector subsystem 115. The selector subsystem 115 can send at least two signals 116 to a beam generator subsystem 120. In addition, a reference subsystem 125 can be used to provide at least two reference outputs 126 to the beam generator subsystem 120. The wafer 101 is positioned using an X-Y-Z-theta stage 102 where the wafer 101 is adjacent to a wafer alignment sensor 104, supported by a platform base 103.

The optical metrology system 100 can comprise a first selectable reflection subsystem 130 that can be used to direct at least two outputs 121 from the beam generator subsystem 120 on a first path 131 when operating in a first mode “LOW AOI” (AOI, Angle of Incidence) or on a second path 132 when operating in a second mode “HIGH AOI”. When the first selectable reflection subsystem 130 is operating in the first mode “LOW AOI”, at least two of the outputs 121 from the beam generator subsystem 120 can be directed to a first reflection subsystem 140 on the first path 131, and at least two outputs 141 from the first reflection subsystem can be directed to a high angle focusing subsystem 145. When the first selectable reflection subsystem 130 is operating in the second mode “HIGH AOI”, at least two of the outputs 121 from the beam generator subsystem 120 can be directed to a low angle focusing subsystem 135 on the second path 132. Alternatively, other modes in addition to “LOW AOI” and “HIGH AOI” may be used and other configurations may be used.

When the metrology system 100 is operating in the first mode “LOW AOI”, at least two of the outputs 146 from the high angle focusing subsystem 145 can be directed to the wafer 101. For example, a high angle of incidence can be used. When the metrology system 100 is operating in the second mode “HIGH AOI”, at least two of the outputs 136 from the low angle focusing subsystem 135 can be directed to the wafer 101. For example, a low angle of incidence can be used. Alternatively, other modes may be used and other configurations may be used.

The optical metrology system 100 can comprise a high angle collection subsystem 155, a low angle collection subsystem 165, a second reflection subsystem 150, and a second selectable reflection subsystem 160.

When the metrology system 100 is operating in the first mode “LOW AOI”, at least two of the outputs 156 from the wafer 101 can be directed to the high angle collection subsystem 155. For example, a high angle of incidence can be used. In addition, the high angle collection subsystem 155 can process the outputs 156 obtained from the wafer 101 and high angle collection subsystem 155 can provide outputs 151 to the second reflection subsystem 150, and the second reflection subsystem 150 can provide outputs 152 to the second selectable reflection subsystem 160. When the second selectable reflection subsystem 160 is operating in the first mode “LOW AOI” the outputs 152 from the second reflection subsystem 150 can be directed to the analyzer subsystem 170. For example, at least two blocking elements can be moved allowing the outputs 152 from the second reflection subsystem 150 to pass through the second selectable reflection subsystem 160 with a minimum amount of loss.

When the metrology system 100 is operating in the second mode “HIGH AOI”, at least two of the outputs 166 from the wafer 101 can be directed to the low angle collection subsystem 165. For example, a low angle of incidence can be used. In addition, the low angle collection subsystem 165 can process the outputs 166 obtained from the wafer 101 and low angle collection subsystem 165 can provide outputs 161 to the second selectable reflection subsystem 160. When the second selectable reflection subsystem 160 is operating in the second mode “HIGH AOI” the outputs 162 from the second selectable reflection subsystem 160 can be directed to the analyzer subsystem 170.

When the metrology system 100 is operating in the first mode “LOW AOI”, high incident angle data from the wafer 101 can be analyzed using the analyzer subsystem 170, and when the metrology system 100 is operating in the second mode “HIGH AOI”, low incident angle data from the wafer 101 can be analyzed using the analyzer subsystem 170.

Metrology system 100 can include at least two measurement subsystems 175. At least two of the measurement subsystems 175 can include at least two detectors such as spectrometers. For example, the spectrometers can operate from the Deep-Ultra-Violet to the visible regions of the spectrum.

The metrology system 100 can include at least two camera subsystems 180, at least two illumination and imaging subsystems 182 coupled to at least two of the camera subsystems 180. In addition, the metrology system 100 can also include at least two illuminator subsystems 184 that can be coupled to at least two of the imaging subsystems 182. (describe output 186)

In some embodiments, the metrology system 100 can include at least two auto-focusing subsystems 190. Alternatively, other focusing techniques may be used.

At least two of the controllers (not shown) in at least two of the subsystems (105, 110, 115, 120, 125, 130, 135, 140, 145, 150, 155, 160, 165, 170, 175, 180, 182, 190, and 195) can be used when performing measurements of the structures. A controller can receive real-signal data to update subsystem, processing element, process, recipe, profile, image, pattern, and/or model data. At least two of the subsystems (105, 110, 115, 120, 125, 130, 135, 140, 145, 150, 155, 160, 165, 170, 175, 180, 182, and 190) can exchange data using at least two Semiconductor Equipment Communications Standard (SECS) messages, can read and/or remove information, can feed forward, and/or can feedback the information, and/or can send information as a SECS message.

Those skilled in the art will recognize that at least two of the subsystems (105, 110, 115, 120, 125, 130, 135, 140, 145, 150, 155, 160, 165, 170, 175, 180, 182, 190, and 195) can include computers and memory components (not shown) as required. For example, the memory components (not shown) can be used for storing information and instructions to be executed by computers (not shown) and may be used for storing temporary variables or other intermediate information during the execution of instructions by the various computers/processors in the metrology system 100. At least two of the subsystems (105, 110, 115, 120, 125, 130, 135, 140, 145, 150, 155, 160, 165, 170, 175, 180, 185, and 190 and 195) can include the means for reading data and/or instructions from a computer readable medium and can comprise the means for writing data and/or instructions to a computer readable medium. The metrology system 100 can perform a portion of or all of the processing steps of the invention in response to the computers/processors in the processing system executing at least two sequences of at least two instructions contained in a memory and/or received in a message. Such instructions may be received from another computer, a computer readable medium, or a network connection. In addition, at least two of the subsystems (105, 110, 115, 120, 125, 130, 135, 140, 145, 150, 155, 160, 165, 170, 175, 180, 182, and 190 and 195) can comprise control applications, Graphical User Interface (GUI) components, and/or database components.

It should be noted that the beam when the metrology system 100 is operating in the first mode “LOW AOI” with a high incident angle data from the wafer 101 all the way to the measurement subsystems 175, (output 166, 161, 162, and 171) and when the metrology system 100 is operating in the second mode “HIGH AOI” with a low incident angle data from the wafer 101 all the way to the measurement subsystems 175, (output 156, 151, 152, 162, and 171) is referred to as diffraction signal(s).

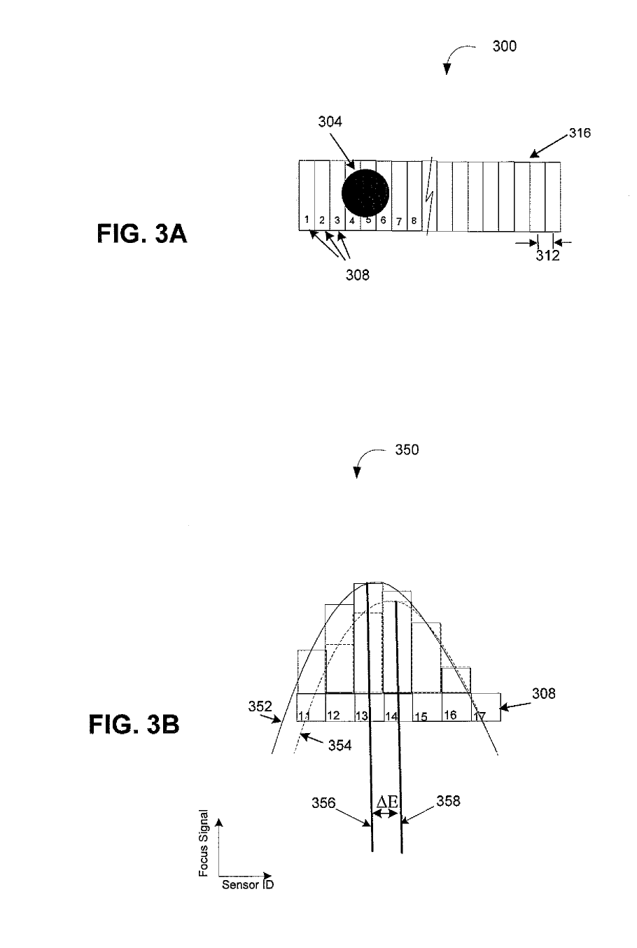

FIG. 3A depicts top-view of an exemplary focus detector 300 with a focus detection sensor array 316 where the sensors include a pitch 312 and identification, labeled numerically as individual sensors 308. The focus detection sensor array 316 may comprise 256, 512, 1024 or higher number of sensors 308 arranged linearly in a contiguous manner. The pitch 312 for sensors 308 represents the distance between the center of a sensor to the center of a next contiguous sensor. A focus detection beam 304 is directed to the focus detection sensor array 316 where the focus detection beam 304 strikes sensors 308 identified as sensor 3, sensor 4, sensor 5, and sensor 6. Sensor 5 has the most exposure to the focus detection beam 304 and would register the highest value of the reading of the focus detection beam 304 by the focus detector 300. Sensors 1, 2, 7, and 8 and those not identified would also register a value of the reading due to ambient light or background electromagnetic noise.

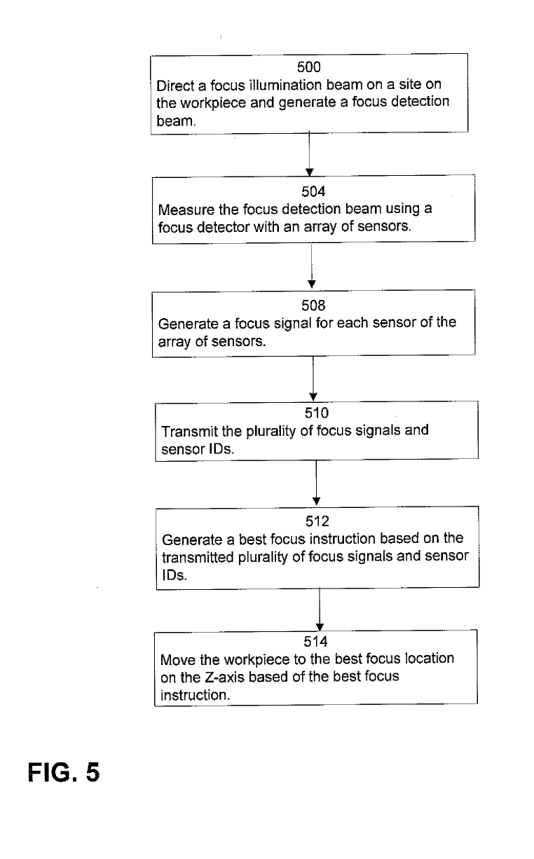

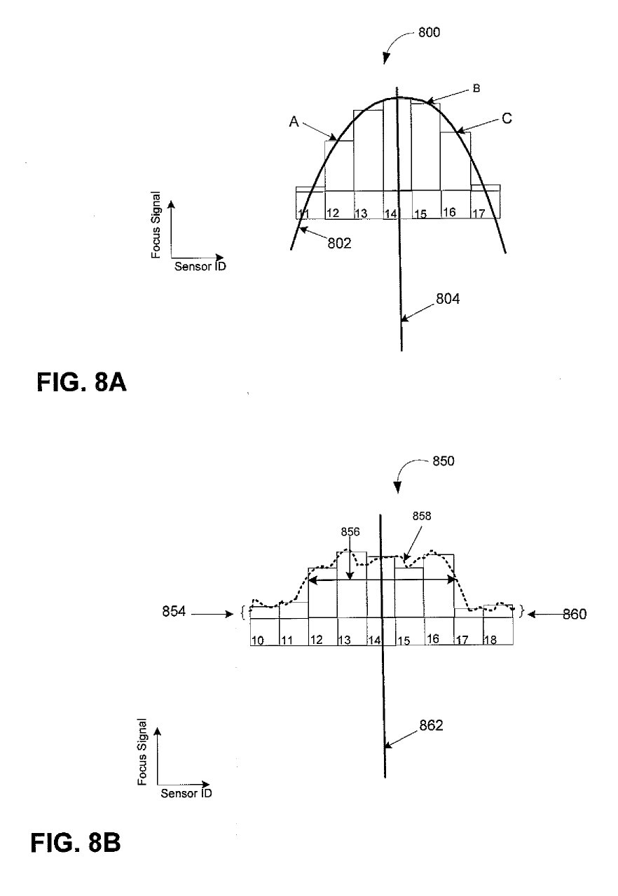

FIG. 3B depicts an exemplary graph 350 of two sets of detector signals measured by a focus detector for the identified sensors. The first graph 352 from the left depicts a graph of measured focus signals for a calibration run of a focus detector using a first workpiece. The highest value of the first graph 352 corresponds to sensor 13 and is highlighted by line 356 and represents the best focus location in Z-axis for the type of workpiece and structures on the workpiece. The best focus location is determined using graphical techniques as described above, or by using curve fitting algorithms, and the like in conjunction with a correlation of the selected sensor corresponding to the highest value of the focus signal or corresponding to the center of the focus beam to the wafer position in the Z-axis. The graphical technique is illustrated using a graph like FIG. 3B whereas the technique using curve fitting is described in connection with FIGS. 5A and 8B. Referring to FIG. 3B, using a second workpiece similar to the first workpiece in a regular measurement run, measured focus signals are collected for all the sensors 308 and values for the same sensors that are depicted in the first graph 352 are overlaid and shown as second graph 354. The highest value of the focus signal for second graph 354 corresponds to sensor 14 and is highlighted by line 358. The distance between the calibrated highest value on line 356 for the calibration run and regular measurement run is the incremental error, ΔE, in the current position of the second workpiece compared to the calibrated best focus position in the Z-axis. As will shown later below, ΔE can be used by a processor (not shown) together with the pitch of the sensors, equipment characteristics of the motion control subsystem (not shown) to generate the best focus instruction.

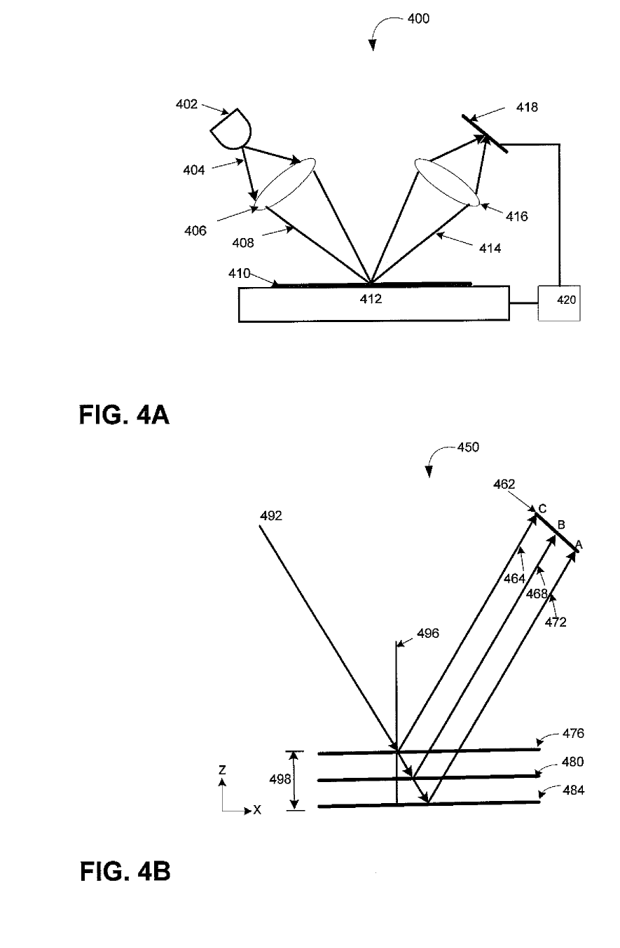

FIG. 4A depicts an architectural diagram illustrating an auto focusing subsystem of an optical metrology tool. Referring to FIG. 4A, the auto focusing subsystem of an optical metrology tool 400 comprises a focus illumination source 402 generating a focus illumination beam 404 that is directed to optical focusing component 406. The optical focusing component 406 generates a focus projection beam 408 onto a workpiece 410. The focusing illumination source 402 may be a monochromatic beam generator such as a laser beam source or an infrared light emitting diode (LED) or the like. The focus illumination beam 404 may comprise mirrors and/or lenses. As mentioned above, the workpiece 410 may be a wafer, a photomask, substrate or the like. The workpiece 410 is coupled to a motion control subsystem 412 that may be an X-Y-Z theta stage. A focus detection beam 414 diffracts off workpiece 410 onto an optical collecting component 416, which in turn projects the beam onto focus detector 418. Optical collecting component 416 may comprise mirrors and/or lenses. Focus detector 418 is an array detector that may have 256, 512, or more sensors or where the pitch of the array of sensors is 12.5 nanometers or smaller. The focus detector 418 may have a speed that is appropriate for the range of intended applications; the focus detector 418 may operate at 2 megahertz or higher. The measured focus signal from the focus detector 418 is transmitted to processor 420 where the best focus instruction for workpiece 410 is determined and transmitted to motion control subsystem 412. As mentioned above, the processor 420 takes into account the sensor position of the calibration highest reading of the focus signal compared to the highest reading of the focus signal for the workpiece 410. The processor 420 may be a processor associated with the auto focusing subsystem 400, or a processor associated with the motion control subsystem 412, or any processor coupled to the optical metrology system. Motion control subsystem 412 uses the transmitted best focus instruction to move workpiece 410 to the best focus position in the Z-axis.

FIG. 4B depicts an architectural diagram illustrating diffraction of an auto focus beam off a workpiece at different positions on the Z-axis. A focus illumination beam 492 is diffracted off a workpiece where the workpiece 484 can be a first position on the Z-axis 496, generating a focus detection beam 472 towards focus detector 462 at point A. The workpiece 484 can be moved to a second position on the Z-axis 496 with a motion control system (not shown) such as the motion control subsystem 412 in FIG. 4A and can be situated on the Z-axis 496 as workpiece 480. The same focus illumination beam 492 at the same angle of incidence is diffracted off workpiece 480 towards a different spot compared to workpiece 484, the illumination beam 492 generating a focus detection beam 468 proceeding to detector 462 at point B. Similarly, workpiece 484 can be moved to a third position on the Z-axis 496 with a motion control system (not shown) such as the motion control subsystem 412 in FIG. 4A and can be situated on the Z-axis 496 as workpiece 476. The same focus illumination beam 492 at the same angle of incidence is diffracted off the workpiece 476 at a different spot compared to workpiece 484, the illumination beam 492 generating a focus detection beam 464 proceeding to detector 462 at point C. Assume the focus detection beam 472 proceeding to focus detector 462 at point A corresponds to the lowest level on the Z-axis 496 where the workpiece can be measured for best focus determination. The workpiece would be moved upwards using a motion control system (not shown) on the Z-axis to find the best focus location. Similarly, assume the focus detection beam 464 proceeding to focus detector 462 at point C corresponds to the highest level on Z-axis 496 where the workpiece can be measured for best focus determination. The workpiece would be moved downwards using a motion control system (not shown) on the Z-axis to find the best focus location. Referring to FIG. 4B, the vertical distance 498 between workpiece 476 and workpiece 484 represents the measurable adjustment range in the Z-axis 496 to get a workpiece in best focus. For a new semiconductor application, the best focus and best focus location in the Z-axis for a workpiece such as a wafer may be performed prior to metrology operations in production mode. Calibration may include the steps of loading the wafer in the motion control system, positioning the wafer and the focus detector to the highest or lowest level in the Z-axis, making a series of measurements of the focus signal for each sensor in the array of sensors of the focus detector, and correlating the movement of the wafer on the Z-axis to the determined best focus and best focus location. This calibrated best focus position is used for determining the best focus instruction, step 512 of FIG. 5.

FIG. 5 depicts an exemplary flowchart for auto focusing the workpiece in the Z-axis using an auto focus detector with an array of sensors. In step 500, a focus illumination beam is directed on a site on the workpiece and generates a focus detection beam. In one embodiment, the focus illumination beam is focused on the structure that will be measured by the optical metrology system. For example, if the optical metrology system that includes the auto focusing subsystem is measuring a patterned resist structure, then the auto focusing subsystem illumination beam is focused on the patterned resist structure. In other embodiments, other sites such as a test area or test structure formed on the scribe lines of the workpiece can also be used for this purpose. In step 504, the focus detection beam is measured using a focus detector with an array of sensors, such as the focus detector depicted in FIG. 3A. The focus detection beam is directed onto one or more sensors of the array of sensors as shown in FIG. 3A. In step 508, a focus signal for each sensor in the array of sensors is generated by the focus detector for the focus detection beam directed on the sensor plus any ambient light or other electromagnetic noise present.

In step 510 of FIG. 5, the focus signal for a sensor and the sensor ID are transmitted to a processor for all sensors in the array of sensors. The focus processor may be part of the auto focus subsystem or may be a processor of the optical metrology system or a processor of a process tool in an integrated metrology application. In step 512, a best focus instruction is generated based, among other things, on the transmitted plurality of focus signals and associated sensor IDs, the pitch of the sensor array, and mechanical specifications of the motion control subsystem. The focus signals and sensor IDs can be used to determine the sensor ID that has the highest focus signal value. The sensor ID with the highest focus signal value and the sensor pitch is used to derive a difference between the Z-axis location of the workpiece and the calibrated best focus position of the workpiece. The calibrated best position of the workpiece is determined by using previously measured data with the same type of workpiece and similar structure being measured by the optical metrology system. The difference between the Z-axis location of the workpiece and the calibrated best focus position of the workpiece is illustrated in FIG. 3B as ΔE. Based on the mechanical specifications of the motion control subsystem and the difference between the Z-axis location of the workpiece and the calibrated best focus position, ΔE, a best focus instruction is generated by the processor. The best focus instruction may include the distance the workpiece may have to move up or down to get to the best focus location in the Z-axis. The best focus instruction may be computer instructions or servo commands to move the workpiece in the particular model of the motion control subsystem to the best focus location in the Z-axis. In step 514, the workpiece is moved to the best focus location on the Z-axis based on the best focus instruction.

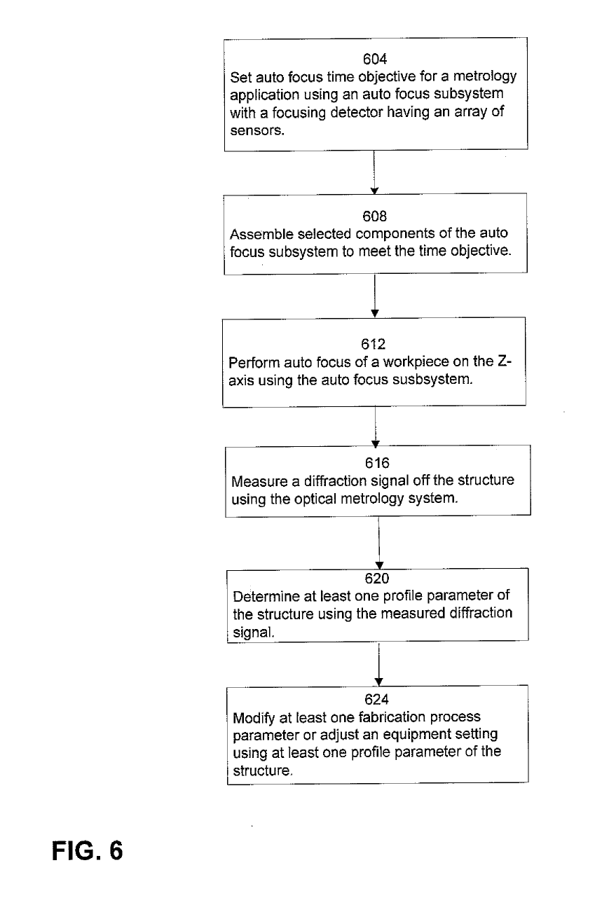

FIG. 6 depicts an exemplary flowchart for designing an auto focus subsystem of an optical metrology system to meet a time objective, and for using the optical metrology system to extract structure profile parameters of a workpiece and control a fabrication process. In step 604, an auto focus time objective for a metrology application using an auto focus subsystem with a focus detector having an array of sensors is set. The time objective is coordinated with the other metrology steps needed to complete metrology steps for a structure in a workpiece. For example, in semiconductor wafer processing, assume the optical metrology system is designed to measure 150 or 200 wafers per hour. The time for a single wafer and time for a metrology step such as auto focusing are calculated based on the throughput. The calculated time to support the throughput objective of say 200 wafers per hour is the time objective set in this step. In step 608, selected components of the auto focus subsystem to meet the time objective are assembled and integrated into the optical metrology system. As described in relation to FIG. 4A, the components of an auto focus subsystem include a focus illumination source, an optical focusing component, an optical collecting component, a focus detector, and a processor. As mentioned above, a motion control subsystem is used to move the wafer along the Z-axis to the best focus location. The primary components that affect the time objective include the focus detector, the processor, and the motion control subsystem. The focus detector speed is typically measured in hertz or cycles per second. Speed of linear array focus detectors vary from 1, 2, 5 megahertz or higher. There are many processors available presently that can handle the data processing required by the method associated with FIG. 5 for transmitting focus signals and sensor IDs and generating the best focus instruction. Similarly, the motion control subsystem selected needs to have a range of speeds that would enable meeting the set time objective. For more details on steps needed to design an optical metrology system to meet time objectives, refer to U.S. patent application Ser. No. 12/050,053, entitled “METHOD OF DESIGNING AN OPTICAL METROLOGY SYSTEM OPTIMIZED FOR OPERATING TIME BUDGET” by Tian et al., filed on Mar. 17, 2008, which is incorporated herein by reference in its entirety.

In step 612, auto focus of the workpiece on the Z-axis is performed using the auto focus subsystem. An exemplary method of auto focusing the workpiece is described in connection with FIG. 5. In step 616, one or more diffraction signals off a target structure on the workpiece are measured using the optical metrology system and using the workpiece focused on the Z-axis in step 612. In step 620, at least one profile parameter of the structure is determined using the measured one or more diffraction signals. If the workpiece is a semiconductor wafer, the one profile parameter may be a top critical dimension (CD), a bottom CD, or a sidewall angle. In step 624, at least one fabrication process parameter or equipment setting is modified using the determined at least one profile parameter of the structure. For example, if the workpiece is a wafer, the fabrication process parameter may include a temperature, exposure dose or focus, etchant concentration or gas flow rate. As mentioned above, the optical metrology system may be part of a standalone metrology module or integrated in a fabrication cluster.

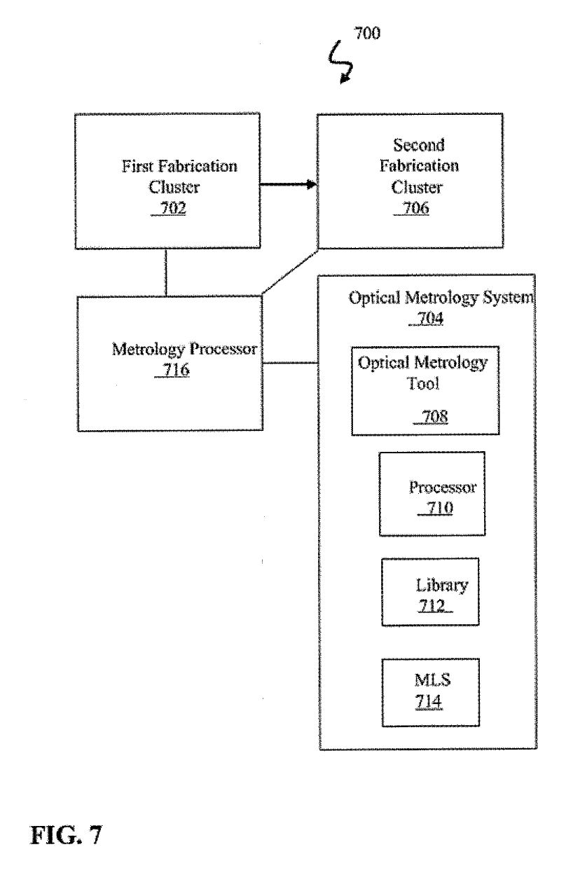

FIG. 7 is an exemplary block diagram of a system for determining and utilizing profile parameters for automated process and equipment control. System 700 includes a first fabrication cluster 702 and optical metrology system 704. System 700 also includes a second fabrication cluster 706. Although the second fabrication cluster 706 is depicted in FIG. 7 as being subsequent to first fabrication cluster 702, it should be recognized that second fabrication cluster 706 can be located prior to first fabrication cluster 702 in system 700 (e.g. and in the manufacturing process flow).

A photolithographic process, such as exposing and/or developing a photoresist layer applied to a wafer, can be performed using first fabrication cluster 702. Optical metrology system 704 is similar to optical metrology system 40 of FIG. 1. In one exemplary embodiment, optical metrology system 704 includes an optical metrology tool 708 and processor 710. Optical metrology tool 708 is configured to measure a diffraction signal off of the structure. Processor 710 is configured to compare the measured diffraction signal measured by the optical metrology tool designed to meet plurality of design goals to a simulated diffraction signal. As mentioned above, the simulated diffraction is determined using a set of profile parameters of the structure and numerical analysis based on the Maxwell equations of electromagnetic diffraction. In one exemplary embodiment, optical metrology system 704 can also include a library 712 with a plurality of simulated diffraction signals and a plurality of values of one or more profile parameters associated with the plurality of simulated diffraction signals. As described above, the library can be generated in advance; metrology processor 710 can compare a measured diffraction signal off a structure to the plurality of simulated diffraction signals in the library. When a matching simulated diffraction signal is found, the one or more values of the profile parameters associated with the matching simulated diffraction signal in the library is assumed to be the one or more values of the profile parameters used in the wafer application to fabricate the structure.

System 700 also includes a metrology processor 716. In one exemplary embodiment, processor 710 can transmit the one or more values of the one or more profile parameters to metrology processor 716. Metrology processor 716 can then adjust one or more process parameters or equipment settings of the first fabrication cluster 702 based on the one or more values of the one or more profile parameters determined using optical metrology system 704. Metrology processor 716 can also adjust one or more process parameters or equipment settings of the second fabrication cluster 706 based on the one or more values of the one or more profile parameters determined using optical metrology system 704. As noted above, the second fabrication cluster 706 can process the wafer before or after the first fabrication cluster 702. In another exemplary embodiment, processor 710 is configured to train machine learning system 714 using the set of measured diffraction signals as inputs to machine learning system 714 and profile parameters as the expected outputs of machine learning system 714.

FIG. 8A depicts an exemplary graph 800 of the focus signal measured for the sensors identified and data point characteristics of the best fitting curve. The focus signal for exemplary sensors 11 to 17 are shown in graph 802 of focus signal as a function of sensor ID. As mentioned above, the focus signal and corresponding sensor ID are sent to the processor where the highest value of the focus signal is determined. Visually in the graph 802, highest focus signal value is for sensor ID number 14. In one embodiment, highest focus signal value can be determined using a processor that can be part of the auto focusing subsystem such as the processor 420 in FIG. 4A. Alternatively, the slope of the graph 802 at points A, B, and C can be used to determine the position of the highest value of the focus signal 804 using the processor 420 in FIG. 4A. A focus signal value and corresponding sensor ID comprise the focus data point and a plurality of these focus data points can be used to determine the sensor ID with the highest focus signal value. In another embodiment, the values of the focus signal for a number of sensors such as sensor IDs 12, 15, and 16 indicated in the graph 802 as A, B, and C, respectively, can be used in a curve fitting algorithm to determine the highest value of the focus signal. Examples of curve fitting algorithms include numerical methods. Numerical methods include polynomial curve fitting, least square curve fining and the like. Alternatively, algorithms may include the use of software such as Mathlab™ owned by Mathworks™, Fityk™ a freeware, or the like. In other embodiments, custom software may be written to determine the highest focus signal using the set of focus signal and corresponding ID for all the sensors and the software may be run on a processor, such as the processor 420 in FIG. 4A.

FIG. 8B depicts an exemplary graph 850 of the focus signal 858 measured for exemplary sensors 10 to 18. The focus detector may have a sensor array of 512, 1024, or more sensors. FIG. 8B only shows sensors in the vicinity where several contiguous sensors receive focus signals greater than noise signal values. The measured focus signal 858 for the array of sensors includes noise signals, 854 and 860; the noise signals being typically small in comparison to the focus signal associated with the focus detection beam. When the focus detection beam is not uniform and/or the intensity distribution of focus detection beam does not follow a Gaussian curve, (highest at the center and progressively gets less intense away from the center), the graph 850 of the focus signal may be as depicted in FIG. 8B. The sensor that received the strongest focus signal is not readily apparent. One exemplary method of handling the non-uniform detection beam is to calculate the equivalent center of the beam. One technique is to draw a line, such as line 856, that is above the noise signals, 854 and 860, and take the middle point of line 856, depicted by the vertical line 862. Another technique, as mentioned above, involves using the focus signal and sensor IDs as focus data points that are input to curve fitting algorithms such as numerical methods, including polynomial curve fitting, least square curve fitting and the like. Alternatively, algorithms may include the use of software such as Mathlab™ owned by Mathworks, Fityk™ a freeware, or the like. As mentioned above, custom software may be written to determine the equivalent highest focus signal using the set of focus signal and corresponding ID for all the sensors and run on a processor, such as the processor 420 in FIG. 4A. Other automated curve fitting techniques may also be used.

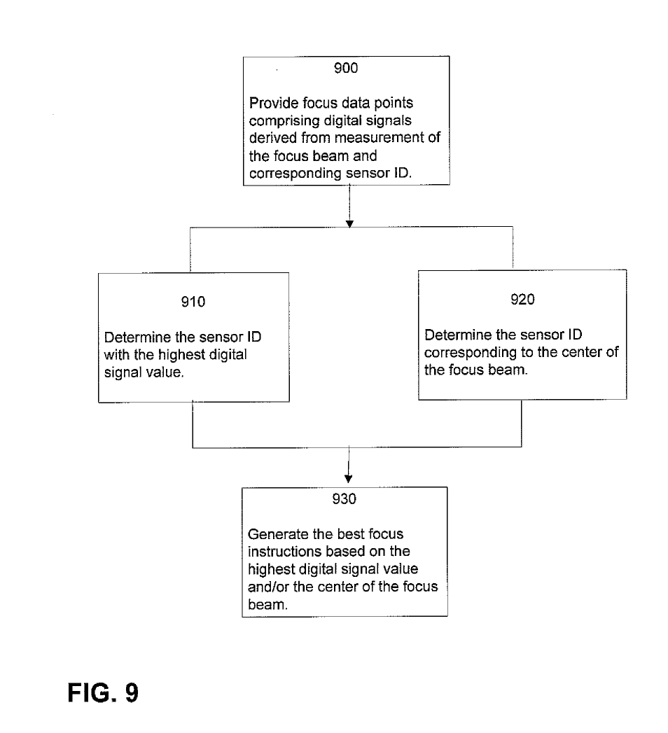

FIG. 9 depicts an exemplary flowchart for generating the best focus instruction for an auto focus detector with an array of sensors. In step 900, focus data points comprising digital signals derived from measurements of the focus beam and the corresponding sensor ID are provided. These focus beam measurements and corresponding sensor ID may be obtained from a local focus detector or received as transmissions from a remote focus detector. As mentioned above, different methods may be utilized to determine the sensor ID to be used as the basis for generating the best focus instruction. In step 910, in one embodiment, the sensor ID with the highest digital signal value is determined and used in generating the best focus instruction. In another embodiment, as shown in step 920, the sensor ID corresponding to the center of the focus beam may be used in generating the best focus instruction. As mentioned above, several techniques such as taking the middle point of the area above the noise level of the focus signal, use of curve fitting algorithms, and use of curve fitting software or custom curve fitting program code may be utilized. In step 930, the highest digital signal value and/or the center to the focus beam is used to determine the sensor ID for generating the best focus instruction. The best focus instruction can comprise directions to the motion control system to move the workpiece to the best focus location on the Z-axis.

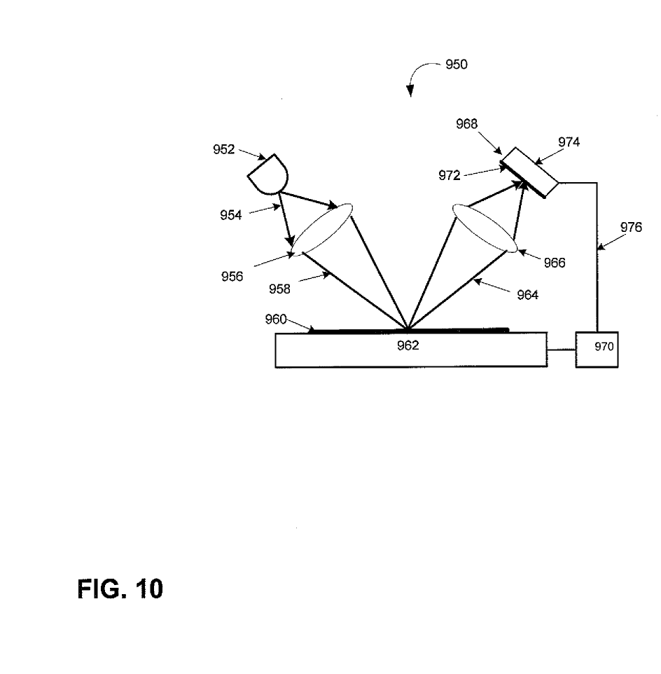

FIG. 10 depicts an architectural diagram illustrating an auto focusing subsystem 950 of an optical metrology tool where the focusing subsystem includes an analog-to-digital converter 974. The auto focusing subsystem 950 functions in a similar manner like auto focusing subsystem 400 in FIG. 4A and the functions of the focus illumination source 952, focus illumination beam 954, optical focusing component 956, focus projection beam 958, workpiece 960, motion control system 962, focus detection beam 964, and optical collecting component 966 are similar to counterparts in FIG. 4A. In FIG. 10, the focus detector 968 is shown in more detail; focus detector 968 comprises the array of sensors 972 and an analog-to-digital converter 974. The analog-to-digital converter 974 has a circuitry and logic unit (not shown) that can change the integration time of the focusing subsystem 950. Integration time is the total amount of time required for the analog-to-digital converter 974 to scan each sensor of the array of sensors 972 and transmit the digital signal data 976 to the processor 970. If the integration time is longer, the signal to noise ratio (SNR) in the digital signal data 976 can be higher; conversely, if the integration time is set to a shorter duration, the SNR in the digital signal data 976 may be lower and the noise in the signal may substantially affect the accuracy of the auto focusing process. On the other hand, if the integration time is very long, the required throughput of workpieces per unit time may not be met.

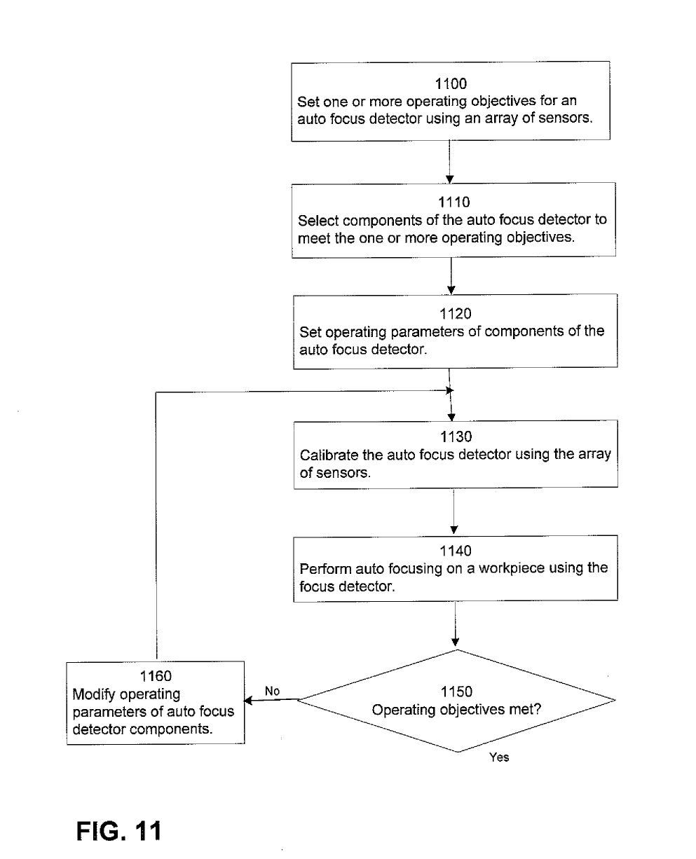

FIG. 11 depicts an exemplary flowchart for auto focusing the workpiece in the Z-axis using an auto focus detector with an array of sensors where one or more operating objectives are optimized. In step 1100, one or more operating objectives for the auto focus detector using an array of sensors are set. The one or more operating objectives may include a throughput objective, for example, of 200 workpieces or more per hour. This overall throughput objective is further converted into a time budget for each auto focusing process step performed by the auto focus detector, for example, 2 to 3 milliseconds to auto focus a structure on a site where there may be one or more sites on the workpiece. Another operating objective may include signal to noise ratio (SNR) of the measured focus signal, for example, an SNR of 20. Another operating objective may include the integration time for the array of sensors. For example, two operating objectives may include integration time of 1.0 to 1.5 millisecond and SNR greater than 15. Other objectives may include the length of time to adjust the auto focusing of the workpiece when the workpiece is moved relative to the focusing subsystem such as when a new site or a new structure in the site is used as a target for auto focusing. For a detailed description of optimizing time budgets for optical metrology process steps, refer to U.S. patent application Ser. No. 12/050,053 entitled METHOD OF DESIGNING AN OPTICAL METROLOGY SYSTEM OPTIMIZED FOR OPERATING TIME BUDGET, filed on Mar. 17, 2008, which is incorporated herein by reference in its entirety. For a detailed description of optimizing objectives or design goals for optical metrology, refer to U.S. patent application Ser. No. 12/141,754 entitled OPTICAL METROLOGY SYSTEM OPTIMIZED WITH DESIGN GOALS, filed on Jun. 18, 2008, which is also incorporated herein by reference in its entirety.

In step 1110, components of the auto focus detector are selected to meet the one or more operating objectives. As mentioned above, components of the auto focus detector include the array of sensors, an analog-to-digital converter, and circuitry to couple the analog-to-digital converter to a processor. The analog-to-digital converter can have a range of conversion speeds that can be set by an operator or set by a program in a processor. Furthermore, certain analog-to-digital converter models from Hamamatsu Inc. and Analog Devices Inc. have a range of models with varying performance speeds from 1 to 10 megahertz. In step 1120, operating parameters of components of the auto focus detector are set. For example, operating parameters of the analog-to-digital converter can include the integration speed of the device, which may be set to complete the integration at 10, 20, 25, or 30 microseconds. In step 1130, the auto focus detector is calibrated using a plurality of measured focus beam measurements from the plurality of sensors and associated sensor IDs. Typically, a structure on the workpiece is selected and used as a target for auto focusing. The sensor with the highest focus signal value or the sensor at the center of the beam as determined in the method described in relation to FIGS. 8A and 8B are stored in a processor. The processor may be part of the focusing subsystem or a processor in the optical metrology system or a processor of the standalone optical metrology system or a processor of fabrication cluster in an integrated optical metrology system.

In step 1140, auto focusing of the workpiece using the focus detector is performed. An exemplary method for performing the auto focus is described in relation to the flowchart in FIG. 5. In step 1150, the actual one or more operating objectives are compared with the set one or more operating objectives. If the set one or more operating objectives are not met, one or more operating parameters of the auto focus detector components are modified in step 1160, and the calibrating step 1130, the auto focusing step 1140, and comparison of actual one or more operating objectives to the set one or more operating objectives in step 1150, are iterated until the one or more operating objectives are met. Operating parameters such as integration speed may be adjusted on the analog-to-digital converter 974 in FIG. 10 to meet the integration time and signal to noise ratio objective. Additionally, the analog-to-digital converter 974 may be replaced with a model with the appropriate speed or a wider range of data capture speeds. Products from Hamamatsu Inc. and Analog Devices Inc. have a range of analog-to-digital converters and sensor arrays with varying performance speeds from 1 to 10 megahertz. In another embodiment, the speed for processing the focus signals and sensor IDs, generating the best focus instruction or moving the workpiece to the best focus location may be modified by using a faster processor such as in the processor 970 in FIG. 10.

Although exemplary embodiments have been described, various modifications can be made without departing from the spirit and/or scope of the present invention. For example, although a focus detector array was primarily used to describe the embodiments of the invention; other position sensitive detectors may also be used. For automated process control, the fabrication clusters may be a track, etch, deposition, chemical-mechanical polishing, thermal, or cleaning fabrication cluster. Furthermore, the elements required for the auto focusing are substantially the same regardless of whether the optical metrology system is integrated in a fabrication cluster or used in a standalone metrology setup. Therefore, the present invention should not be construed as being limited to the specific forms shown in the drawings and described above.

What is claimed:

1. An apparatus for automatically focusing a workpiece on the Z-axis, the workpiece being positioned for optical metrology of structures on the workpiece, the apparatus comprising:
an auto focusing subsystem comprising:
a light source generating a focus illumination beam directed to a workpiece, the focus illumination beam generating a focus detection beam;
a focus detector comprising:
an array of sensors, the array of sensors having a pitch, each sensor of the array of sensors having a sensor identification (ID) and generating a focus signal upon exposure to the focus detection beam; and
an analog-to-digital converter coupled to the array of sensors, the analog-to-digital converter configured to convert the focus signal from each sensor in the array of sensors into a digital signal and to transmit the digital signal and associated sensor ID;
a processor coupled to the focus detector and configured to generate a best focus instruction based on the plurality of transmitted digital signal and associated sensor ID for each sensor in the array of sensors; and
a motion control system configured to position the workpiece on a best focus location on the Z-axis using the best focus instruction from the processor;
wherein the generation of the focus signal, transmission of the focus signal and associated ID of each sensor of the array of sensors, generation of best focus instruction, and positioning the workpiece to the best focus location are completed within a set time duration.

2. The apparatus of claim 1, wherein the processor generating the best focus instruction uses an algorithm based on the pitch of the sensors and the sensor ID having the highest digital signal value.

3. The apparatus of claim 1, wherein the light source includes an infrared light emitting diode or a laser device.

4. The apparatus of claim 1, wherein the workpiece is a wafer, a photomask, or a substrate.

5. The apparatus of claim 1, wherein the auto focusing subsystem, the processor, and the motion control system are components of an optical metrology tool.

6. The apparatus of claim 5, wherein the optical metrology tool is part of an optical metrology system.

7. The apparatus of claim 6, wherein the optical metrology system is integrated with a semiconductor process tool or wherein the optical metrology system is part of a standalone metrology module.

8. The apparatus of claim 1, wherein the set time duration is 30 microseconds or less.

9. The apparatus of claim 1, wherein the array of sensors comprises 256 or more sensors or wherein the pitch of the array of sensors is 12.5 nanometers or smaller.

10. The apparatus of claim 1, wherein the analog-to-digital converter performs conversion of the focus signal at two megahertz or faster.

11. The apparatus of claim 2, wherein the sensor ID having the highest digital signal value is determined using a curve fitting algorithm.

12. The apparatus of claim 1, wherein the processor generating the best focus instruction uses an algorithm based on the pitch of the sensors and the sensor ID located at the center of the focus detection beam.

13. A method of auto focusing a workpiece in an optical metrology tool, the optical metrology tool integrated with a fabrication cluster, the method comprising:
directing a focus illumination beam on a site on the workpiece, the focus illumination beam generating a focus detection beam;
measuring the focus detection beam using a focus detector, the focus detector having an array of sensors, each sensor of the array of sensors having a sensor identification (ID), the focus detector measuring the focus detection beam projected on a plurality of sensors in the array of sensors,
generating a focus signal for each sensor in the array of sensors; and
transmitting the plurality of focus signals and associated sensor IDs to a processor;
generating a best focus instruction based on the transmitted plurality of focus signals and associated sensor IDs using the processor; and
moving the workpiece on the Z-axis based on the best focus instruction;
wherein the generation of the focus signal, transmission of the focus signal and associated ID of each sensor of the array of sensors, generation of best focus instruction, and positioning the workpiece to the best focus location are completed within a set time duration.

14. The method of claim 13, wherein the processor generating the best focus instruction uses an algorithm based on the pitch of the sensors and the sensor ID having the highest digital signal value.

15. The method of claim 13, wherein the array of sensors comprises 256 or more sensors or wherein the pitch of the array of sensors is 12.5 nanometers or smaller.

16. The method claim of 13, wherein the measurement of the focus detection beam for the array of sensors is performed at a speed of two megahertz or faster.

17. A method of measuring structures on a workpiece using an optical metrology system, the optical metrology system integrated with a fabrication cluster, the method comprising:
performing auto focus of a workpiece utilizing an auto focus subsystem, the auto focus subsystem including a focusing light source, a motion control system, and a focus detector, the focus detector having an array of sensors, each sensor of the array of sensors having a pitch and an identification (ID) wherein performance of the auto focus of the workpiece is performed to meet operating objectives;
directing one or more illumination beams onto a structure on the workpiece, the one or more illumination beams generating one or more diffraction signals;
measuring the one or more diffraction signals from the structure; and
determining at least one profile parameter of the structure using the one or more diffraction signals; and
modifying at least one fabrication process parameter or an equipment setting using at least one profile parameter of the structure.

18. The method of claim 17, wherein performing auto focus of the workpiece comprises:
generating an auto focus beam using the focusing light source;
measuring the auto focus beam using the focus detector, the focus detector further converting the measured auto focus beam into an auto focus signal for each sensor of the array of sensors;
transmitting the auto focus signal and associated ID of each sensor of the array of sensors;
generating a best focus instruction based on the transmitted auto focus signal and associated ID of each sensor of the array of sensors; and
positioning the workpiece using the best focus instruction using the motion control system

19. The method of claim 18, wherein generating the best focus instruction uses an algorithm based on the pitch of the sensors and the sensor ID having the highest digital signal value or an algorithm based on the pitch of the sensors and the sensor ID located at the center of the focus detection beam.

20. The method of claim 17, wherein the workpiece is a wafer, a photomask, or a substrate and the fabrication cluster is a track, etch, deposition, thermal processing, cleaning, or planarization cluster.
